(19) United States
(12) Patent Application Publication
(10) Pub. No.: US 2025/0335841 A1
(43) Pub. Date: Oct. 30, 2025

(54) APPARATUS AND METHOD FOR PREVENTING PARTS SUPPLY ERRORS

(71) Applicant: SK On Co., Ltd., Seoul (KR)

(72) Inventors: Yun U CHANG, Daejeon (KR); Jeong Been KIM, Daejeon (KR); Seok Hwan JI, Daejeon (KR); Yong Hun JUNG, Daejeon (KR)

(21) Appl. No.: 19/188,022

(22) Filed: Apr. 24, 2025

(30) Foreign Application Priority Data
Apr. 25, 2024 (KR) 10-2024-0055597

(51) Int. Cl. G06Q 10/0631; G06Q 50/04; H01M 10/04

(52) U.S. Cl. CPC G06Q 10/06312; G06Q 50/04; H01M 10/04

(57) ABSTRACT

Proposed is an apparatus and a method for preventing parts supply errors. The method includes inputting a recipe for a battery module into assembly equipment, supplying a part to the assembly equipment, reading a code displayed on the part supplied to the assembly equipment, determining, by the assembly equipment in the first determination step, whether the recipe stored in the assembly equipment matches the supplied part on the basis of the read code, determining, by an equipment management system in the second determination step, whether a recipe stored in the equipment management system matches the supplied part on the basis of the read code, and stopping operation of the assembly equipment and outputting an alarm when at least one result of the first determination step or the second determination step comes out as mismatch.

### CROSS REFERENCE TO RELATED APPLICATION

The present application claims priority to Korean Patent Application No. 10-2024-0055597, filed Apr. 25, 2024, the entire contents of which is incorporated herein for all purposes by this reference.

### TECHNICAL FIELD

The present disclosure relates to an apparatus and a method for preventing parts supply errors.

### BACKGROUND

A battery module may be manufactured by storing multiple battery cells in a casing. The battery module may further include a variety of parts in addition to the battery cells and the casing. For example, a battery module may be manufactured by assembling a busbar, a busbar assembly, a casing, and various other parts. Each part is supplied to assembly equipment, and the assembly equipment assembles the parts to manufacture a battery module. The assembly equipment manufactures battery modules by assembling designated parts in designated positions according to a battery module production recipe.

### SUMMARY

According to an aspect of the present disclosure, an apparatus and a method for preventing parts supply errors are provided to ensure that the parts supplied to assembly equipment correspond with a battery module production recipe.

A device and method for manufacturing battery modules according to an aspect of the present disclosure may be applied to the manufacturing process of batteries widely applied in green technology fields such as electric vehicles, battery charging stations, and battery-based solar and wind power generation.

A device and method for manufacturing battery modules according to an aspect of the present disclosure may be applied to the manufacturing process of batteries used in eco-friendly electric vehicles, hybrid vehicles, etc. to combat climate change by suppressing air pollution and greenhouse gas emissions.

According to an aspect of the present disclosure, a method for preventing parts supply errors may include: inputting a recipe for a battery module into assembly equipment; supplying a part to the assembly equipment; reading a code displayed on the part supplied to the assembly equipment; determining, by the assembly equipment in a first determination step, whether the recipe stored in the assembly equipment matches the supplied part on the basis of the read code; determining, by an equipment management system in a second determination step, whether a recipe stored in the equipment management system matches the supplied part on the basis of the read code; and stopping operation of the assembly equipment and outputting an alarm when at least one result of the first determination step or the second determination step comes out as mismatch.

According to an embodiment, the method for preventing parts supply errors may further include: determining, in a third determination step, whether the results of the first determination step and the results of the second determination step are all matched; and proceeding, by the assembly equipment, with assembly when the results of the first determination step and the results of the second determination step are all matched.

According to an embodiment, the step of reading a code may include: photographing, by a code reader of the assembly equipment, a code of the part supplied to a part receiver of the assembly equipment; obtaining, by a controller of the assembly equipment, a character string from the code captured by the code reader; and extracting, by the controller, a number of the part from the character string.

According to an embodiment, the step of inputting a recipe for a battery module into assembly equipment may include: providing a recipe input screen for the battery module by means of an input/output interface of the assembly equipment; and deactivating, when one of model names displayed on the recipe input screen is selected, remaining model names are deactivated so as not to be selected.

According to an embodiment, the step of inputting a recipe for a battery module into assembly equipment may include: displaying a plurality of manufacturers for selection for a plurality of parts on the recipe input screen, and when a manufacturer is selected for one part, a manufacturer of other parts related to the one part is also selected as the same manufacturer.

According to an embodiment, the method for preventing parts supply errors may further include determining, in a fourth determination step, whether a position where the code is displayed on the part is a normal position after the step of reading a code displayed on the part supplied to the assembly equipment, wherein in the step of outputting an alarm, when the position where the code is displayed on the part is not the normal position, the assembly equipment may be stopped and an alarm may be output.

According to an embodiment, the method for preventing parts supply errors may further include: checking, by a check sensor of the assembly equipment, a designated point of the supplied part after the step of reading a code displayed on the part supplied to the assembly equipment; and determining, in a fifth determination step, whether an orientation of the part is a normal orientation on the basis of an output of the check sensor, wherein in the step of outputting an alarm, when the orientation of the part is not the normal orientation, the assembly equipment may be stopped and an alarm may be output.

According to an embodiment, the recipe for the battery module may be created on the basis of a part number assigned and classified according to criteria set for one or more of a model, a part type, a manufacturer, or specifications of a battery module.

According to an aspect of the present disclosure, an apparatus for preventing parts supply errors may include: multiple pieces of assembly equipment installed along an assembly line for a battery module and each of which has a code reader that reads a code of a part supplied to a part receiver; and an equipment management system configured to manage the multiple pieces of assembly equipment, wherein the assembly equipment may perform a first determination step of determining whether a recipe stored in the assembly equipment matches the supplied part on the basis of the read code, the equipment management system may perform a second determination step of determining whether a recipe stored in the equipment management system matches the supplied part on the basis of the read code, and when at least one result of the first determination step or the second determination step comes out as mismatch, the assembly equipment may stop operation and output an alarm.

According to an embodiment, the equipment management system may perform a third determination step of determining whether the results of the first determination step and the results of the second determination step are all matched, and when the results of the first determination step and the results of the second determination step are all matched, the assembly equipment may proceed with assembly.

According to an embodiment, the assembly equipment may include: the code reader configured to photograph the code of the part supplied to the part receiver of the assembly equipment and provide the photographed code to a controller of the assembly equipment; and the controller configured to obtain a character string from the code captured by the code reader and extract a number of the part from the character string.

According to an embodiment, the controller may further include an input/output interface configured to provide a recipe input screen for a battery module, wherein the recipe input screen may be such that when one of model names displayed on the screen is selected, remaining model names are deactivated so as not to be selected.

According to an embodiment, the controller may further include an input/output interface configured to provide a recipe input screen for a battery module, wherein the recipe input screen may be such that a plurality of manufacturers is displayed for selection for a plurality of parts on the screen, and when a manufacturer is selected for one part, a manufacturer of other parts related to the one part is also selected as the same manufacturer.

According to an embodiment, the assembly equipment may further perform a fourth determination step of recognizing a position of the code displayed on the part in an image acquired by the code reader by photographing the code displayed on the part and determining whether the position displayed on the part is a normal position, and when the position where the code is displayed on the part is not the normal position, may stop operation and output an alarm.

According to an embodiment, the assembly equipment may further include a check sensor installed at a predetermined location in the assembly equipment to check a designated point of the supplied part, and the assembly equipment may further perform a fifth determination step of determining whether an orientation of the part is a normal orientation on the basis of an output of the check sensor, and when the orientation of the part is not the normal orientation, may stop operation and output an alarm.

The features and advantages of the present disclosure will become more apparent from the following detailed description based on the accompanying drawings.

Prior to this, terms or words used in this specification and claims should not be construed in their usual, dictionary meaning, and must be interpreted with meaning and concept consistent with the technical idea of the present disclosure on the basis of the principle that the inventor can define terminology appropriately to explain his or her invention in the best way possible.

According to an embodiment of the present disclosure, it is possible to prevent mixing of parts different from those in a recipe into a battery module.

According to an embodiment of the present disclosure, it is possible to minimize parts supply errors and improve the operation rate of an assembly line by checking in various ways whether the parts supplied to assembly equipment match a recipe.

### BRIEF DESCRIPTION OF THE DRAWINGS

FIG. 1 is a view showing an apparatus for preventing parts supply errors according to an embodiment.

FIG. 2 is a view showing a battery module manufactured using the apparatus for preventing parts supply errors according to an embodiment.

FIG. 3 is a view showing assembly equipment according to an embodiment.

FIG. 4 is a view showing a controller according to an embodiment.

FIG. 5 is a flowchart showing the steps of a method for preventing parts supply errors according to an embodiment.

FIG. 6 is a view showing a recipe according to an embodiment.

FIG. 7 is a view showing a recipe input screen according to an embodiment.

FIG. 8 is a view showing each step of the method for preventing parts supply errors according to an embodiment.

FIG. 9 is a flowchart showing steps for reading a code according to an embodiment.

FIG. 10 is a view showing the process of extracting a part number from a code according to an embodiment.

FIG. 11 is a view showing steps for checking the orientation of a part using the position of a code according to an embodiment.

FIG. 12 is a view showing a process for checking the location of a code displayed on a part according to an embodiment.

FIG. 13 is a view showing steps for checking the orientation of a part using a check sensor according to an embodiment.

FIG. 14 is a view showing the location of the check sensor according to an embodiment.

FIG. 15 is a view showing the operation of the check sensor according to the orientation of a part according to an embodiment.

FIG. 16 is a view showing the process of checking the orientation of a part using the structure of a tray storing the part.

### DETAILED DESCRIPTION

Hereinafter, the present disclosure will be described in detail (with reference to the attached drawings). However, this is merely illustrative and the present disclosure is not limited to the specific embodiments described by way of example.

It should be noted that, in assigning reference numerals to components in the drawings, identical components are assigned the same reference numerals as much as possible even if they are shown in different drawings, and similar reference numbers are assigned to similar components.

Terms used to describe an embodiment of the present disclosure are not intended to limit the disclosure. It should be noted that singular expressions include plural expressions unless the context clearly dictates otherwise.

The drawings may be schematic or exaggerated for the purpose of illustrating the embodiments. In this document, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., used to distinguish one component from another component, and the components are not limited by the terms.

It should be understood that terms that indicate direction such as up, down, left, right, X-axis, Y-axis, Z-axis, etc., are only for convenience of explanation and may be expressed differently depending on the location of an observer or the location of an object.

The embodiments described in this document and the accompanying drawings are not intended to limit the present disclosure to specific embodiments. The present disclosure is to be understood as including various modifications, equivalents, and/or alternatives of the embodiments.

Hereinafter, an embodiment of the present disclosure will be described in detail with reference to the attached drawings.

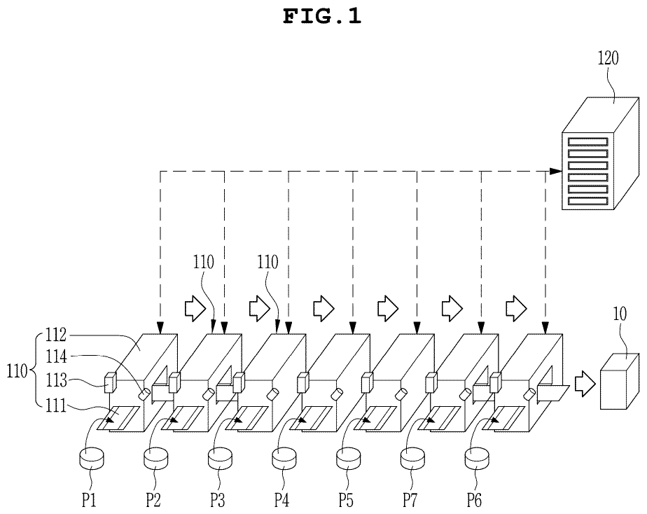

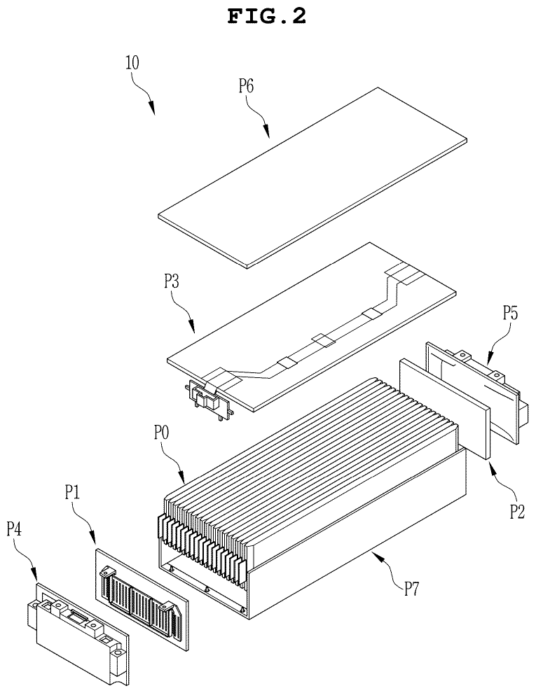

FIG. 1 is a view showing an apparatus 100 for preventing parts supply errors according to an embodiment. FIG. 2 is a view showing a battery module 10 manufactured using the apparatus 100 for preventing parts supply errors according to an embodiment.

Assembly equipment 110 may assemble parts of the battery module 10. Multiple pieces of assembly equipment 110 may be installed along an assembly line. Individual assembly equipment 110 may be supplied with different parts. The assembly equipment 110 may assemble parts and provide the assembled parts to the next equipment.

The multiple pieces of assembly equipment 110 may be controlled by an equipment management system 120. The equipment management system 120 may manage the operation or stop of the assembly equipment 110. The equipment management system 120 may determine whether a part supply error exists on the basis of data provided by the assembly equipment 110. The equipment management system 120 may be implemented as a computer device. For example, the equipment management system 120 may be a device such as a PC, tablet PC, server computer, or PLC.

The battery module 10 may include a plurality of battery cells. The battery module 10 may be assembled from a plurality of parts. The battery module 10 may include a front busbar P1, a rear busbar P2, a busbar module assembly P3, a front casing P4, a rear casing P5, an upper casing P6, and a lower casing P7. The battery module 10 may further include a cable, a sheet, a plate, and other various parts. The battery module 10 may be manufactured with a structure other than that shown in FIG. 2.

The front busbar P1 may be supplied to first assembly equipment 110, the rear busbar P2 may be supplied to second assembly equipment 110, the busbar module assembly P3 may be supplied to third assembly equipment 110, the front casing P4 may be supplied to fourth assembly equipment 110, the rear casing P5 may be supplied to fifth assembly equipment 110, the lower casing P7 may be supplied to sixth assembly equipment 110, and the upper casing P6 may be supplied to seventh assembly equipment 110. The first to seventh assembly equipment 110 may manufacture the battery module 10 shown in FIG. 2 by receiving parts and assembling the received parts.

The apparatus 100 for preventing parts supply errors according to an embodiment may also be applied to assembly equipment 110 for assembling a battery module 10 of a different structure other than the assembly equipment 110 for assembling the battery module 10 of the described structure.

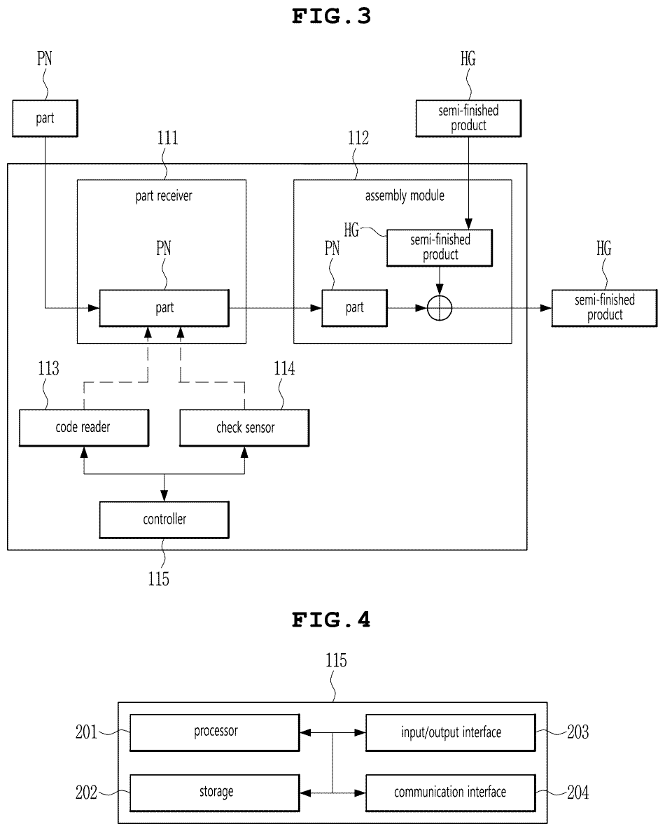

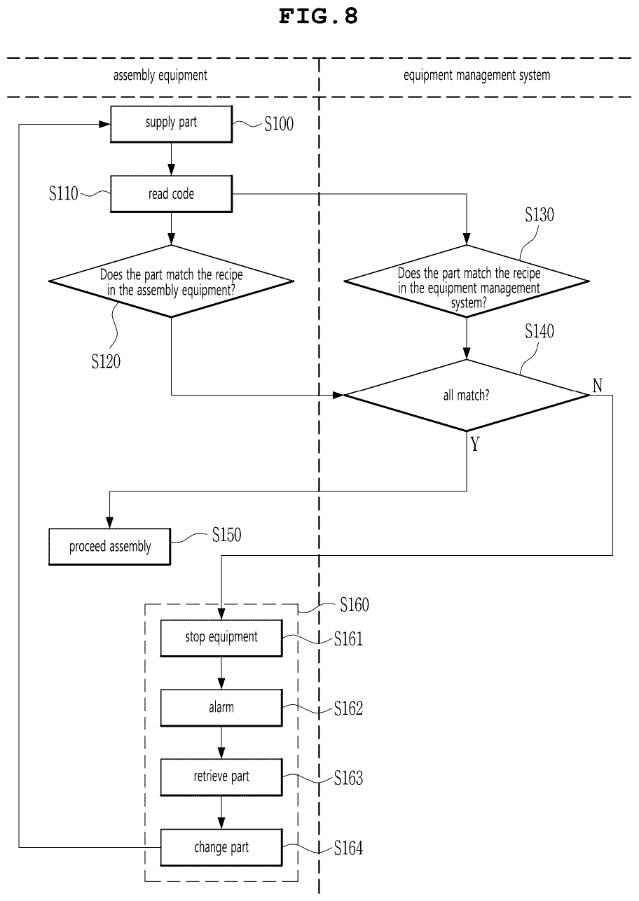

FIG. 3 is a view showing assembly equipment 110 according to an embodiment. FIG. 8 is also referred to.

The apparatus 100 for preventing parts supply errors according to an embodiment may include: the multiple pieces of assembly equipment 110 installed along the assembly line for the battery module 10 and including a code reader 113 that reads a code of a part supplied to a part receiver 111; the equipment management system 120 for managing the multiple pieces of assembly equipment 110. The assembly equipment 110 may perform a first determination step (S120) in which the assembly equipment 110 determines, on the basis of the read code, whether a recipe stored in the assembly equipment 110 matches a supplied part, and the equipment management system 120 may perform a second determination step (S130) in which the equipment management system 120 determines, on the basis of the read code, whether a recipe stored in the equipment management system 120 matches a supplied part. The assembly equipment 110 may stop operation and output an alarm when at least one result of the first determination step (S120) or the second determination step (S130) comes out as “mismatch”.

In addition, the equipment management system 120 may further perform a third determination step (S140) of determining whether the results of the first determination step (S120) and the results of the second determination step (S130) are all matched, and the assembly equipment 110 may proceed with assembly when the results of the first determination step (S120) and the results of the second determination step (S130) are all matched.

Since the first determination step (S120) is performed in the assembly equipment 110 and the second determination step (S130) is performed in the equipment management system 120, each step may be performed independently. When the results of the first determination step (S120) and the results of the second determination step (S130) all come out as “match”, it is finally determined that the parts and recipes match in the third determination step (S140) and the assembly operation may be performed normally. When any result from either the first determination step (S120) or the second determination step (S130) comes out as “mismatch”, the assembly operation may be stopped because there is an error in the supplied part or recipe. Since the first determination step (S120) and the second determination step (S130) double check for parts supply errors, a part supply error may be detected without being missed.

Parts supply errors may include errors in which a part different from that specified in the recipe is supplied, and errors in which a part is supplied in an orientation different from the specified orientation. The apparatus 100 for preventing parts supply errors according to an embodiment may detect an error in which a part different from that specified in the recipe is supplied through the first determination step (S120), the second determination step (S130), and the third determination step (S140), and may detect an error in which a part is supplied in an orientation different from the specified orientation through a fourth determination step (S170) and a fifth determination step (S190).

The assembly equipment 110 may include the part receiver 111 that receives parts, and an assembly module 112 that assembles parts.

Each assembly equipment 110 may assemble a part into parts PN or a semi-finished product HG delivered from the previous equipment. Each assembly equipment 110 may deliver the semi-finished product HG assembled from the parts PN to the next equipment. The semi-finished product HG refers to a product in which the parts PN are assembled but is not completed into the battery module 10.

The part receiver 111 and the assembly module 112 may have different configurations depending on the part type to be assembled. In the reference sign PN of the part PN, N is a number. For example, the part receiver 111 of the assembly equipment 110 for assembling the front bus bar P1 and the part receiver 111 of the assembly equipment 110 for assembling the front casing P4 may have different configurations. Similarly, the assembly module 112 of the assembly equipment 110 for assembling the front bus bar P1 and the assembly module 112 of the assembly equipment 110 for assembling the front casing P4 may have different configurations. Even if the part receivers 111 and the assembly modules 112 of the multiple pieces of assembly equipment 110 have different configurations, the apparatus 100 for preventing parts supply errors according to an embodiment may be commonly applied.

The assembly equipment 110 may include: the code reader 113 that photographs a code of a part supplied to the part receiver 111 of the assembly equipment 110 and provides the code to a controller 115 of the assembly equipment 110; and the controller 115 that acquires a character string from the code photographed by the code reader 113 and extracts the number of the part from the character string. The controller 115 may extract the part number from the code and perform the first determination step (S120). Details of how the controller 115 extracts the part number from the part code will be described later.

Even if the part supplied to the assembly equipment 110 and the part in the recipe match, when the orientation of the supplied part is different from the specified orientation, assembly may not be performed normally.

The assembly equipment 110 may further perform the fourth decision step (S170) of recognizing the position of a code displayed on a part in an image acquired by the code reader 113 by photographing the code displayed on the part and determining whether the position displayed on the part is the normal position. When the position where the code is displayed on the part is found to be not normal, the assembly equipment 110 may stop operation and output an alarm.

The assembly equipment 110 may further include a check sensor 114 that is installed at a predetermined location in the assembly equipment 110 to check a designated point of the supplied part. The controller 115 of the assembly equipment 110 may further perform the fifth determination step S190 of determining whether the orientation of a part is normal on the basis of the output of the check sensor 114. When the orientation of the part is found to be not normal, the controller 115 may stop operation and output an alarm.

The assembly equipment 110 may use the position of the code displayed on the part to check the orientation of the supplied part. If the position of the code displayed on the part deviates from the specified position, it may be determined that the orientation of the supplied part is not the specified orientation or that a different part (incorrect part that does not match the recipe) has been supplied. If the output of the check sensor 114 is outside the specified range, the assembly equipment 110 may determine that the orientation of the supplied is not the specified orientation or that a different part has been supplied.

FIG. 4 is a view showing the controller 115 according to an embodiment.

The controller 115 may include: one or more processors 201; a storage 202 connected to the processors 201 to transmit and receive data and storing a recipe; an input/output interface 203 that receives input from a manager and displays data or information to the manager; and a communication interface 204 that is connected to a wired or wireless network to transmit and receive commands or data.

The controller 115 is a computer device capable of processing information and is included in each of the multiple pieces of assembly equipment 110 to determine whether there is a part supply error. Alternatively, one controller 115 may determine whether there is a part supply error for the multiple pieces of assembly equipment 110.

The processor 201 may execute program code written to perform each step of the method for preventing parts supply errors according to an embodiment. The program code may be stored in the storage 202. The storage 202 may store data and program codes necessary to perform each step of the method for preventing parts supply errors according to an embodiment.

The input/output interface 203 may include an input device such as a keyboard, mouse, touch pad, or touch screen to receive commands input by the manager. The input/output interface 203 may include a display for providing data or results to the manager and providing a recipe input screen, a touch screen, a speaker for providing an alarm, a warning light, etc.

The communication interface 204 may be connected to a wired or wireless network. The communication interface 204 may use various communication methods such as ethernet, LAN, WAN, IPv4, IPv6, 5G, 6G, Wi-Fi, and Bluetooth. The assembly equipment 110 may transmit and receive data or commands with the equipment management system 120 through the communication interface 204.

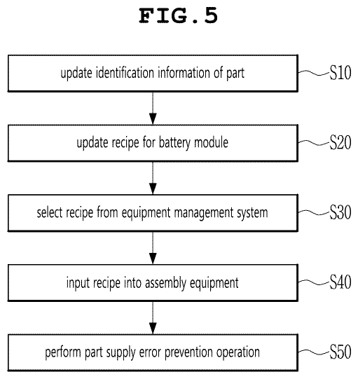

FIG. 5 is a flowchart showing the steps of a method for preventing parts supply errors according to an embodiment.

The method for preventing parts supply errors according to an embodiment may include: updating the identification information of a part (S10); updating the recipe for the battery module 10 (S20); selecting a recipe from the equipment management system 120 (S30); inputting the recipe into the assembly equipment 110 (S40); and performing a part supply error prevention operation while assembling the battery module 10 (S50).

The step of updating the identification information of a part (S10) is a process of storing the part's number, manufacturer, specifications, location of the code, normal output range of a measurement sensor, etc. in the assembly equipment 110 and the equipment management system 120. Part identification information need to be stored in the assembly equipment 110 and the equipment management system 120 to detect supply errors in supplied parts.

The step of updating the recipe for the battery module 10 (S20) is a process of storing a recipe determined according to the design of the battery module 10 in the equipment management system 120. The recipe for the battery module 10 may be created on the basis of the part identification information. The recipe is data that determines which part should be supplied to which equipment and in what orientation. Since various types of battery modules 10 may be assembled on one assembly line, a plurality of recipes may be stored in the equipment management system 120.

The step of selecting a recipe in the equipment management system 120 (S30) is a process to select a recipe for the battery module 10 to be currently assembled by the assembly equipment 110 from among the plurality of recipes stored in the equipment management system 120. The manager may select one of the plurality of recipes stored in the equipment management system 120. Upon receiving the manager's input, the equipment management system 120 may determine whether a part supplied to the assembly equipment 110 matches the selected recipe.

The step of inputting the recipe into the assembly equipment 110 (S40) is a process in which the manager inputs a recipe using the input/output interface 203 of the assembly equipment 110. While inputting the recipe into the assembly equipment 110, the manager may check whether there is an error in the recipe itself stored in the equipment management system 120. By separately performing the step (S40) of inputting the recipe into the assembly equipment 110, the first decision step (S120) performed by the assembly equipment 110 and the second decision step (S130) performed by the equipment management system 120 may be independent decisions.

When the recipe is input to the assembly equipment 110, a part is supplied to the assembly equipment 110 and a manufacturing process for assembling the battery module 10 may proceed. The part supply error prevention operation may be performed while the manufacturing process is in progress (S50). Each step according to the method for preventing parts supply errors may be repeatedly performed while the assembly equipment 110 is operating and parts are supplied.

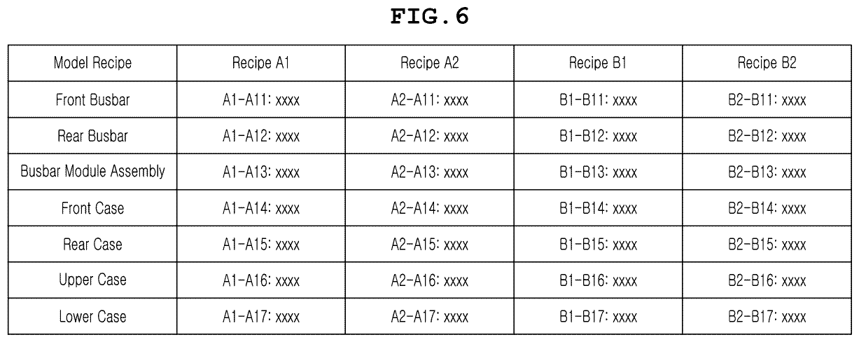

FIG. 6 is a view showing a recipe according to an embodiment.

The recipe for the battery module 10 may be created on the basis of the part number assigned and classified according to criteria set for one or more of the followings: the model, a part type, manufacturer, or specifications of the battery module 10. The part number may be assigned according to classification criteria according to the model of the battery module 10, classification criteria according to the part type, classification criteria according to the manufacturer or specifications, etc. When a new model of the battery module 10 is introduced or a new part is introduced, a new part number may be assigned according to the existing classification criteria.

There may be a plurality of recipes stored in the equipment management system 120 according to an embodiment. Depending on the model of the battery module 10, the model recipe may be different. For example, FIG. 6 shows four recipes. Recipe A1, Recipe A2, Recipe B1, and Recipe B2 are recipes of different models. The recipes may include part numbers. Recipe A1 may include a front busbar with a part number of “A1-A11:xxxx” and a rear busbar with a part number of “A1-A12:xxxx”. A busbar module assembly, a front casing, a rear casing, an upper casing, and a lower casing may also be determined as parts assigned specific numbers.

For example, in “A1-A11:xxxx”, “A1” may represent the model name, “A11” may represent the front bus bar, and “xxxx” may be a letter or number given by specifications, manufacturer, etc. “xxxx” represents any letter or number. Part numbers may be assigned by other classification methods than the one described.

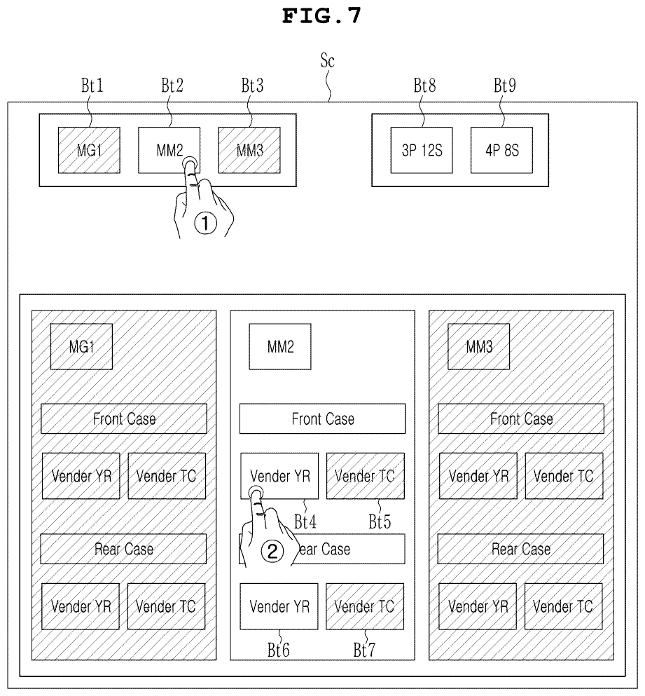

FIG. 7 is a view showing a recipe input screen according to an embodiment.

In the method for preventing parts supply errors according to an embodiment, the step of inputting the recipe for the battery module 10 into the assembly equipment 110 (S40) may further include: providing a recipe input screen for the battery module 10 by means of the input/output interface 203 of the assembly equipment 110; and deactivating the remaining model names so as not to be selected when one of the model names displayed on the recipe input screen is selected. The input/output interface 203 of the controller 115 according to an embodiment may provide a recipe input screen Sc for the battery module 10. When one of the model names displayed on the recipe input screen Sc is selected, the remaining model names may be deactivated so as not to be selected.

The input/output interface 203 may provide the recipe input screen Sc for the manager to input a recipe into the assembly equipment 110. The recipe input screen Sc may provide buttons Bt1, Bt2, and Bt3 for selecting the model name of the battery module 10. There may be a plurality of buttons for selecting the model name of the battery module 10. The recipe input screen Sc may further provide detailed selection buttons Bt4 to Bt9 related to the model of the battery module 10. For example, in FIG. 7, the recipe input screen may provide three selectable buttons Bt1, Bt2, and Bt3 with model names “MG1”, “MM2”, and “MM3”. In addition, as a detailed selection button for each model, buttons Bt4, Bt5, Bt6, and Bt7 may be provided to select parts from two companies, “Vender YR” and “Vender TC”, as the suppliers (vendors) for the front and rear casings for “MG1”.

The manager may input a recipe by selecting the model name and selecting detailed parts. In this process, to prevent the manager from incorrectly inputting the model name and detailed part selection, the input/output interface 203 according to an embodiment may automatically deactivate the remaining unselected model names when the manager selects one of the buttons for selecting the model name among the plurality of battery modules 10. At this time, along with deactivating the model names, the selection button for detailed parts may also be deactivated. As a result, input errors may be prevented where the manager selects a model name and then selects detailed parts related to the unselected model name. For example, if the manager selects the button Bt2 of the MM2 model, the MG1 button Bt1 and the MM3 button Bt3 are disabled, and the selection buttons for detailed parts related to the MG1 model and MM3 model may also be disabled. In FIG. 7, the deactivated area is indicated by hatching.

Similarly, the recipe input screen Sc may provide a button for inputting the connection structure of the battery module 10. For example, the recipe input screen Sc may provide a selectable “3P12S” button Bt8 when the battery module 10 has a 3-parallel/12-series structure, and a “4P8S” button Bt9 when the battery module 10 has a 4-parallel/8-series structure. When the manager selects one of the provided buttons, the other may be disabled to make it unselectable.

The step of inputting the recipe for the battery module 10 into the assembly equipment 110 (S40) may further include a step in which multiple manufacturers are displayed as selectable for multiple parts on the recipe input screen Sc, and when a manufacturer is selected for one part, the manufacturer of other parts related to that part is also selected as the same manufacturer.

On the recipe input screen Sc, multiple manufacturers are displayed for selection for multiple parts, and when a manufacturer is selected for one part, the manufacturer of other parts related to that part is also selected as the same manufacturer.

For example, when the manager selects (\textcircled{2}) the button Bt4 of a part whose supplier is “Vender YR” of the front casing, the button Bt6 of the part of the rear casing supplied as a set with the corresponding part is automatically selected, and the buttons Bt5 and Bt7 of parts of other manufacturers may be disabled.

When a predetermined set of parts exists during the recipe input process, it is possible to prevent the manager from selecting parts from different manufacturers due to errors in the input process.

FIG. 8 is a view showing each step of the method for preventing parts supply errors according to an embodiment.

The method for preventing parts supply errors according to an embodiment may include: inputting the recipe for the battery module 10 into the assembly equipment 110 (S40); supplying a part to the assembly equipment 110 (S100); reading a code displayed on the part supplied to the assembly equipment 110 (S110); a first determination step (S120) in which the assembly equipment 110 determines, on the basis of the read code, whether the recipe stored in the assembly equipment 110 matches the supplied part; a second determination step (S130) in which the equipment management system 120 determines, on the basis of the read code, whether the recipe stored in the equipment management system 120 matches the supplied part; and stopping the operation of the assembly equipment 110 and outputting an alarm (S160) when at least one result of the first determination step (S120) or the second determination step (S130) comes out as “mismatch”.

In addition, the method for preventing parts supply errors according to an embodiment may further include: a third determination step (S140) to determine whether the results of the first determination step S120 and the results of the second determination step (S130) are all matched; and a step (S150) in which the assembly equipment performs assembly when the results of the first determination step (S120) and the results of the second determination step (S130) are all matched.

The step (S40) of inputting the recipe for the battery module 10 into the assembly equipment 110 was explained with reference to FIG. 5. The manager may input the recipe for the battery module 10 using the recipe input screen provided by the input/output interface 203 of the assembly equipment 110.

The step (S100) of supplying a part to the assembly equipment 110 is a process in which a part is transferred to the part receiver 111 of the assembly equipment 110. When a part is seated in the part receiver 111 of the assembly equipment 110, a code reading step (S110) may be performed.

The step (S110) of reading a code displayed on the part supplied to the assembly equipment 110 may be performed by the code reader 113 and the controller 115.

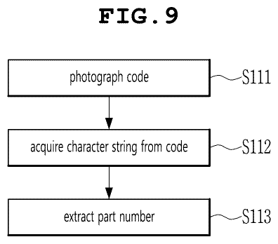

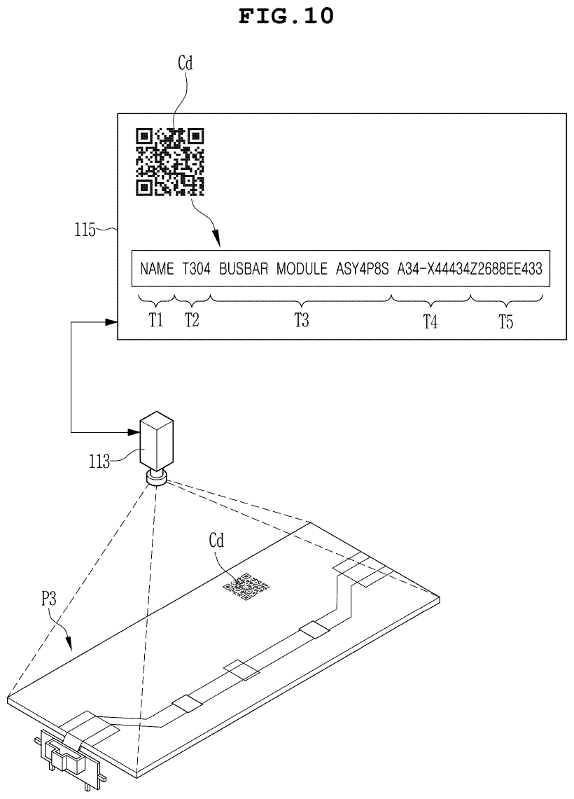

FIG. 9 is a flowchart showing steps for reading a code (S110) according to an embodiment. FIG. 10 is a view showing the process of extracting a part number from a code according to an embodiment.

The step of reading a code (S110) may include: photographing (S111), by the code reader 113 of the assembly equipment 110, a code of the part supplied to the part receiver 111 of the assembly equipment 110; acquiring (S112), by the controller 115 of the assembly equipment 110, a character string from the code captured by the code reader 113; and extracting (S113), by the controller 115, the part number from the character string.

The code reader 113 may perform a step (S111) of photographing a code. The code reader 113 may photograph a code displayed at a designated location on a part using a camera or barcode reader 113. The code reader 113 may generate an image containing a code and provide the image to the controller 115.

The controller 115 may acquire a character string from the code included in the image received from the code reader 113. Depending on the type of code, the controller 115 may acquire a number string in the case of a barcode, and may acquire a character string or number string in the case of a two-dimensional code such as a QR code. For example, as shown in FIG. 10, a string of letters and numbers included in the code may be obtained.

The controller 115 may extract the part number from the character string. The controller 115 knows the location of a string corresponding to the part number in the character string obtained from the code. The location of the string corresponding to the part number may be stored in the storage 202. For example, the character string may be divided into parts T1 to T5, where T1 is the manufacturer's name, T2 is the number assigned by the manufacturer, T3 is the name of the part, T4 is the part number, and T5 is the unique number of the part. The controller 115 may extract only the string corresponding to the part number from the character string.

FIG. 8 is referred again.

The first determination step (S120) may be performed after the code reading step (S110). The first determination step (S120) may be performed by the controller 115 of the assembly equipment 110. In the first determination step (S120), the controller 115 may determine whether the part number in the recipe stored in the assembly equipment 110 matches the part number extracted from the code displayed on the part. The controller 115 may provide the result of the first determination step (S120) to the equipment management system 120. When the part number in the recipe stored in the assembly equipment 110 matches the part number extracted from the code displayed on the part, a “match” may be provided to the equipment management system 120, and when there is no match, a “mismatch” may be provided to the equipment management system 120.

The second determination step (S130) may be performed after the code reading step (S110). The second determination step (S130) may be performed independently from the first determination step (S120). In the code reading step (S110), when the controller 115 provides the equipment management system 120 with the part number extracted from the code displayed on the part, the equipment management system 120 may determine whether the part number in the recipe stored in the equipment management system 120 matches the part number extracted from the code displayed on the part. When the part number in the recipe stored in the equipment management system 120 matches the part number extracted from the code displayed on the part, a “match” may be provided to the third determination step (S140), and when there is no match, a “mismatch” may be provided to the third determination step (S140).

The third determination step (S140) is a process of determining whether the results of the first determination step (S120) and the results of the second determination step (S130) come out as all “match”.

When the result of the third determination step (S140) is “all match” (Y), the equipment management system 120 may instruct the assembly equipment 110 to proceed with assembly (S150).

When the result of the third determination step (S140) is not “all match” (N), the equipment management system 120 may instruct the assembly equipment 110 to stop. When either the result of the first determination step (S120) or the result of the second determination step (S130) comes out as “mismatch”, or both come out as “mismatch”, it is determined that the recipe stored in the assembly equipment 110, the recipe stored in the equipment management system 120, and the part supplied to the assembly equipment 110 do not match, and a step (S160) of stopping the operation of the assembly equipment 110 and outputting an alarm may be performed.

First, because the operation of the assembly equipment 110 needs to be stopped to prevent the problem of incorrect parts being assembled, the equipment is stopped (S161). Since the parts are located in the part receivers 111, the problem of incorrect parts being assembled before assembly may be prevented.

The alarm step (S162) may provide the manager with information on which step among the first determination step (S120) or the second determination step (S130) the result comes out as mismatch. When only one result of the first determination step (S120) or the second determination step (S130) comes out as mismatch, the manager may check whether the recipe stored in the assembly equipment 110 matches the recipe stored in the equipment management system 120. When the results of both the first determination step (S120) and the second determination step (S130) come out as mismatch, the manager may check whether a different part has been supplied.

The manager may retrieve (S163) an incorrect part and change (S164) the incorrect part to a normal part. Afterwards, the assembly process may be normalized by starting again from the parts supply step (S100).

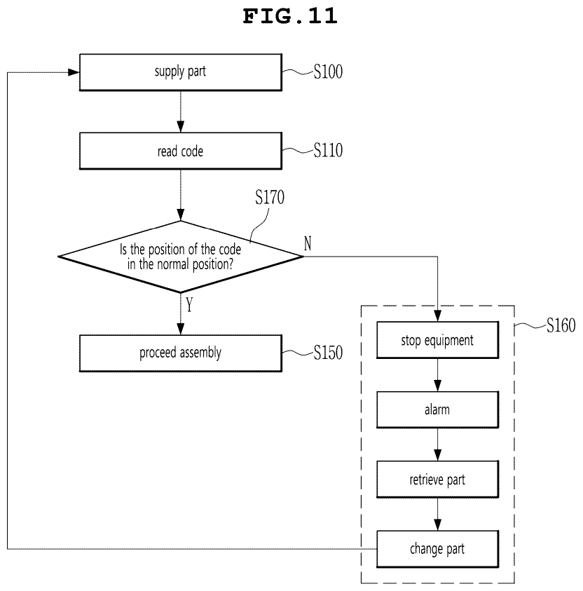

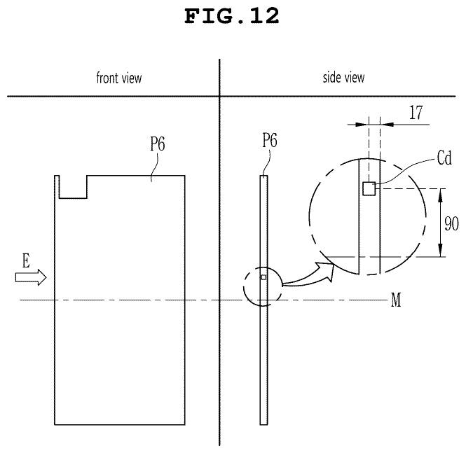

FIG. 11 is a view showing steps for checking the orientation of a part using the position of a code according to an embodiment. FIG. 12 is a view showing a process for checking the location of a code displayed on a part according to an embodiment.

The assembly equipment 110 may further perform the fourth decision step (S170) of recognizing the position of a code displayed on a part in an image acquired by the code reader 113 by photographing the code displayed on the part and determining whether the position displayed on the part is the normal position. When the position where the code is displayed on the part is found to be not normal, the assembly equipment 110 may stop operation and output an alarm.

The method for preventing parts supply errors according to an embodiment may further include: the fourth determination step (S170) of determining whether the position of the code displayed on the part is the normal position after the step (S110) of reading a code displayed on the part supplied to the assembly equipment 110. In addition, in the step (S160) of outputting an alarm, when the position where the code is displayed on the part is not the normal position, the assembly equipment 110 may be stopped and an alarm may be output.

The fourth determination step (S170) is a process of checking whether the part is positioned in the part storage in the correct orientation on the basis of the position of the code displayed on the part. The fourth determination step (S170) may be performed by the code reader 113 and the controller 115. The code reader 113 may photograph a part positioned in the part receiver 111. The code reader 113 may photograph the entire area of the part where the code may be located.

The controller 115 may check the position of a code Cd in the image provided by the code reader 113. The controller 115 may extract the distance at which the code Cd is separated from the boundary of the part. The controller 115 may compare the code position on the part stored in the storage 202 with the code position extracted from the image. The controller 115 may stop the assembly equipment 110 and output an alarm if the code position extracted from the image is not the normal stored position.

For example, in FIG. 12, the code of the upper casing P6 may be displayed on one side of the upper casing P6. The code reader 113 may photograph the area where the code Cd can be located in the upper casing P6. For example, if the upper casing P6 is photographed according to arrow E in the front view of FIG. 12, an image similar to the enlarged view of the side view of FIG. 12 may be obtained. The controller 115 may extract the position of the code Cd from the image received from the code reader 113. When the code is 17 mm from one side of the upper casing P6, which is a specified position, and 90 mm above a center M of the casing, the controller 115 determines that the upper casing P6 has been supplied in the normal position thereof, and may proceed to perform assembly (S150).

If the upper casing P6 is turned upside down, the position of the code Cd will be 90 mm below the center M of the upper casing, and the controller 115 may determine that the part is supplied in the opposite way.

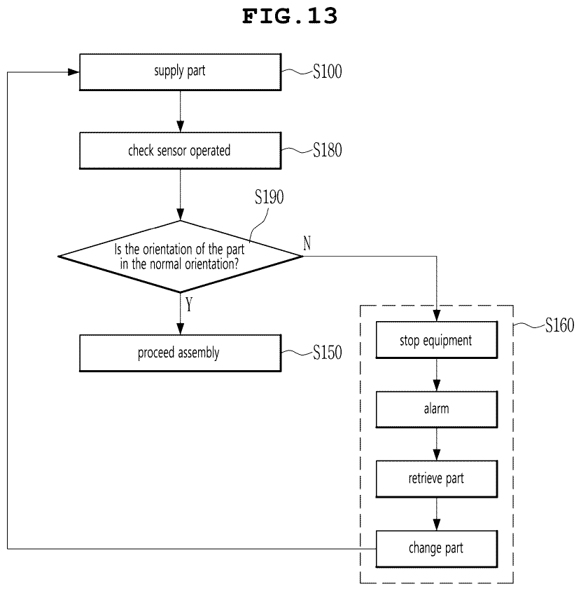

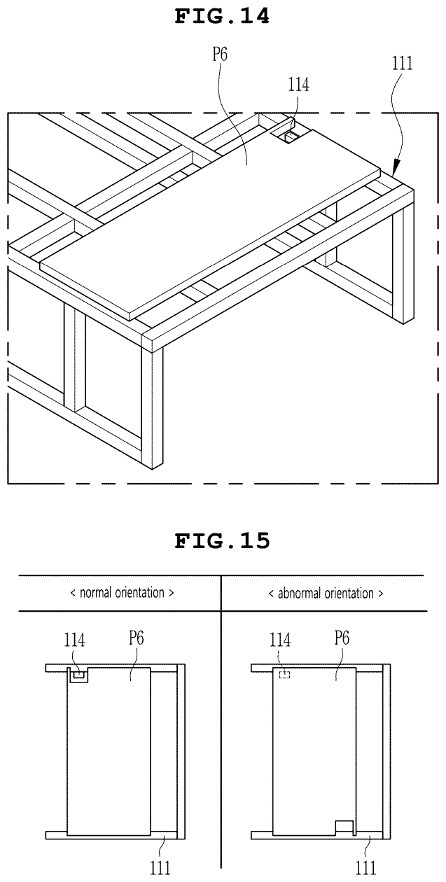

FIG. 13 is a view showing steps for checking the orientation of a part using the check sensor 114 according to an embodiment. FIG. 14 is a view showing the location of the check sensor 114 according to an embodiment. FIG. 15 is a view showing the operation of the check sensor 114 according to the orientation of a part according to an embodiment.

The method for preventing parts supply errors according to an embodiment may further include: after the step (S110) of reading the code displayed on the part supplied to the assembly equipment 110, a step (S180) in which the check sensor 114 of the assembly equipment 110 checks a designated point of the supplied part; and the fifth determination step (S190) of determining whether the orientation of the part is the normal orientation on the basis of the output of the check sensor 114. In the step of outputting an alarm (S160), if the orientation of the part is not the normal orientation, the assembly equipment 110 may be stopped and an alarm may be output.

The step (S180) of checking a designated point of the part may be performed simultaneously with the step of reading a code (S110). The step (S180) of checking a designated point of the part may be performed by the check sensor 114. The check sensor 114 may be installed at a predetermined location in the part receiver 111 of the assembly equipment 110. The check sensor 114 may use various types of sensors such as optical sensors, distance sensors, magnetic sensors, acoustic sensors, ultrasonic sensors, pressure sensors, etc. The check sensor 114 may measure whether an object exists at a designated point on the part and provide the measured value to the controller 115.

For example, if the check sensor 114 is a distance sensor and a specific portion of the part exists at the location where the check sensor 114 is installed, a predetermined distance value may be output as a measured value. However, when a part is oriented differently, the check sensor 114 may measure a different distance value. Alternatively, if the measurement sensor is an optical sensor, a part positioned in a predetermined orientation block light, but a part positioned in the wrong orientation allow light to pass. Thus, the measured values of the optical sensor may be different. In this way, the measured value of the check sensor 114 may be measured differently depending on the orientation of a part.

In FIG. 14, a groove is formed on one side of the upper casing P6. When the upper casing P6 is located in the part receiver 111, the check sensor 114 may be installed at a position corresponding to the groove of the upper casing P6. If the check sensor 114 is a distance sensor, when the check sensor 114 operates, a large measured value of the check sensor 114 may be measured due to the groove of the upper casing P6. However, when the upper casing P6 is positioned in the part receiver 111 in an abnormal orientation, the check sensor 114 is obscured by the upper casing P6. When the check sensor 114 operates, the check sensor 114 may measure a value corresponding to a short distance to the upper casing P6.

The controller 115 may perform the fifth determination step (S190) of determining whether the orientation of the part is the normal orientation on the basis of the measured value output from the check sensor 114. Since the check sensor 114 is placed in the assembly equipment 110 to measure the predetermined position of the part, the controller 115 may determine that the part is supplied in the wrong orientation or that the wrong part is supplied if the measured value of the check sensor 114 is outside the set range.

When the measured value of the check sensor 114 is greater than the reference value, it is determined that the groove of the upper casing P6 is positioned where the check sensor 114 is located, and it may be determined that the upper casing P6 is supplied in the normal orientation. When the measured value of the check sensor 114 is smaller than the reference value, it may be determined that the groove of the upper casing P6 is not positioned where the check sensor 114 is located, and it may be determined that the upper casing P6 is supplied in an abnormal orientation.

The controller 115 may stop the operation of the assembly equipment 110 and output an alarm when it is determined that the part is not in the normal orientation.

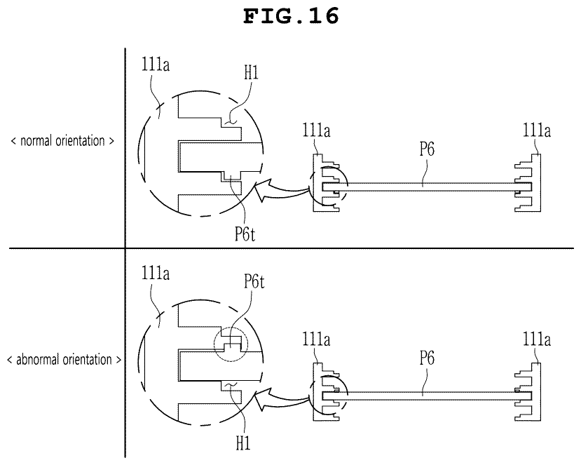

FIG. 16 is a view showing the process of checking the orientation of a part using the structure of a tray 111a storing the part.

The part receiver 111 of the assembly equipment 110 according to an embodiment may include the tray 111a for storing parts. The tray 111a may include a storage space into which a plurality of parts is inserted. The tray 111a may have a structure in which a part is completely stored when the part is stored in the normal orientation, and a portion of the part protrudes when the part is stored in an abnormal orientation.

For example, a protrusion P6t may be present on one side of the front casing P4, and the tray 111a may have a structure in which a groove H1 is formed on one side thereof for accommodating the protrusion P6t of the front casing P4, and there is no groove on the opposite side of the groove H1 so that the protrusion P6t is not accommodated. When the front casing P4 is stored in the tray 111a in the normal orientation, the protrusion P6t of the front casing P4 is inserted into the groove H1 of the tray 111a, so that the front casing P4 may be completely stored in the tray 111a. When the front casing P4 is stored in the tray 111a in an abnormal orientation, the protrusion P6t of the front casing P4 overlaps the tray 111a, and the front casing P4 is not completely stored in the tray 111a.

The check sensor 114 may measure whether a part stored in the tray 111a is completely stored in the tray 111a. The check sensor 114 may output a measurement value outside the set range if there is a protruding portion that is not completely stored in the tray 111a. The controller 115 may compare the measured value of the check sensor 114 with a reference value or a reference range in the fifth determination step (S190). When the controller 115 determines on the basis of the output of the check sensor 114 that the part stored in the tray 111a is located in an abnormal orientation or is a part other than the part in the recipe, the controller 115 may stop the operation of the assembly equipment 110 and output an alarm.

Above, the present disclosure has been described in detail through specific embodiments. The content described above is merely an example of applying the principles of the present disclosure, and other configurations may be further included without departing from the scope of the present disclosure.

What is claimed is:

1. A method for preventing parts supply errors, the method comprising:
inputting a recipe for a battery module into assembly equipment;
supplying a part to the assembly equipment;
reading a code displayed on the part supplied to the assembly equipment;
determining, by the assembly equipment in a first determination step, whether the recipe stored in the assembly equipment matches the supplied part based on the read code;
determining, by an equipment management system in a second determination step, whether a recipe stored in the equipment management system matches the supplied part on a basis of the read code; and
stopping operation of the assembly equipment and outputting an alarm when at least one result of the first determination step or the second determination step comes out as mismatch.

2. The method of claim 1, further comprising:
Determining, in a third determination step, whether the results of the first determination step and the results of the second determination step are all matched; and
proceeding, by the assembly equipment, with assembly when the results of the first determination step and the results of the second determination step are all matched.

3. The method of claim 1, wherein the step of reading a code comprises:
photographing, by a code reader of the assembly equipment, a code of the part supplied to a part receiver of the assembly equipment;
obtaining, by a controller of the assembly equipment, a character string from the code captured by the code reader; and
extracting, by the controller, a number of the part from the character string.

4. The method of claim 1, wherein the step of inputting a recipe for a battery module into assembly equipment comprises:
providing a recipe input screen for the battery module by means of an input/output interface of the assembly equipment; and
deactivating, when one of model names displayed on the recipe input screen is selected, remaining model names are deactivated so as not to be selected.

5. The method of claim 4, wherein the step of inputting a recipe for a battery module into assembly equipment comprises:
displaying a plurality of manufacturers for selection for a plurality of parts on the recipe input screen, and when a manufacturer is selected for one part, a manufacturer of other parts related to the one part is also selected as the same manufacturer.

6. The method of claim 1, further comprising:
Determining, in a fourth determination step, whether a position where the code is displayed on the part is a normal position after the step of reading a code displayed on the part supplied to the assembly equipment,
wherein in the step of outputting an alarm, when the position where the code is displayed on the part is not the normal position, the assembly equipment is stopped and an alarm is output.

7. The method of claim 1, further comprising:
checking, by a check sensor of the assembly equipment, a designated point of the supplied part after the step of reading a code displayed on the part supplied to the assembly equipment; and
determining, in a fifth determination step, whether an orientation of the part is a normal orientation on a basis of an output of the check sensor,
wherein in the step of outputting an alarm, when the orientation of the part is not the normal orientation, the assembly equipment is stopped and an alarm is output.

8. The method of claim 1, wherein the recipe for the battery module is created on a basis of a part number assigned and classified according to criteria set for one or more of a model, a part type, a manufacturer, or specifications of a battery module.

9. An apparatus for preventing parts supply errors, the apparatus comprising:
multiple pieces of assembly equipment installed along an assembly line for a battery module and each of which has a code reader that reads a code of a part supplied to a part receiver; and
an equipment management system configured to manage the multiple pieces of assembly equipment,
wherein each of the multiple pieces of assembly equipment performs a first determination step of determining whether a recipe stored in the each of the multiple pieces of assembly equipment matches the supplied part based on the read code,
the equipment management system performs a second determination step of determining whether a recipe stored in the equipment management system matches the supplied part on a basis of the read code, and
when at least one result of the first determination step or the second determination step comes out as mismatch, the each of the multiple pieces of assembly equipment stops operation and outputs an alarm.

10. The apparatus of claim 9, wherein the equipment management system performs a third determination step of determining whether the results of the first determination step and the results of the second determination step are all matched, and
when the results of the first determination step and the results of the second determination step are all matched, the each of the multiple pieces of assembly equipment proceeds with assembly.

11. The apparatus of claim 9, wherein the each of the multiple pieces of assembly equipment comprises:
the code reader configured to photograph the code of the part supplied to the part receiver of the each of the multiple pieces of assembly equipment and provide the photographed code to a controller of the each of the multiple pieces of assembly equipment; and
the controller configured to obtain a character string from the code captured by the code reader and extract a number of the part from the character string.

12. The apparatus of claim 9, wherein the controller further comprises:
an input/output interface configured to provide a recipe input screen for a battery module,
wherein the recipe input screen is such that when one of model names displayed on the screen is selected, remaining model names are deactivated so as not to be selected.

13. The apparatus of claim 9, wherein the controller further comprises:
an input/output interface configured to provide a recipe input screen for a battery module,
wherein the recipe input screen is such that a plurality of manufacturers is displayed for selection for a plurality of parts on the screen, and when a manufacturer is selected for one part, a manufacturer of other parts related to the one part is also selected as the same manufacturer.

14. The apparatus of claim 9, wherein the each of the multiple pieces of assembly equipment further performs a fourth determination step of recognizing a position of the code displayed on the part in an image acquired by the code reader by photographing the code displayed on the part and determining whether the position displayed on the part is a normal position, and when the position where the code is displayed on the part is not the normal position, stops operation and outputs an alarm.

15. The apparatus of claim 9, wherein the each of the multiple pieces of assembly equipment further comprises:
a check sensor installed at a predetermined location in the each of the multiple pieces of assembly equipment to check a designated point of the supplied part, and
the each of the multiple pieces of assembly equipment further performs a fifth determination step of determining whether an orientation of the part is a normal orientation on a basis of an output of the check sensor, and when the orientation of the part is not the normal orientation, stops operation and outputs an alarm.

16. The apparatus of claim 9, wherein the recipe for the battery module is created on a basis of a part number assigned and classified according to criteria set for one or more of a model, a part type, a manufacturer, or specifications of a battery module.
